(19) United States
(12) Patent Application Publication
(10) Pub. No.: US 2006/0050639 A1
(43) Pub. Date: Mar. 9, 2006

(54) Credit-based method and apparatus for controlling data communications

(76) Inventors: David Stuart, Almonte (CA); Bradley Venables, Nepean (CA); Mark Podlipec, Shrewsbury, MA (US)

Correspondence Address: STEUBING MCGUINNESS & MANARAS LLP, 125 NAGOG PARK, ACTON, MA, 01720, US

(21) Appl. No.: 11/018,909

(22) Filed: Dec. 20, 2004

Related U.S. Application Data
(60) Provisional application No. 60/607,177, filed on Sep. 3, 2004.

(51) Int. Cl. H04L 12/26

(52) U.S. Cl. 370/235

(57) ABSTRACT

A credit-based method and apparatus are provided for controlling data communications between a sender and a receiver coupled by a link. A pipe-cleaning operation resets credits to a known value thereby compensating for errors in the link. Embodiments provide separate links for returning credits and returning pipe-cleaning responses. Further embodiments include a queue split for credit-based management and local management.

### CROSS-REFERENCE OF RELATED APPLICATION

This application claims benefit and priority from U.S. Provisional Application No. 60/607,177, filed Sep. 9, 2004, which is incorporated herein by reference.

### FIELD OF THE INVENTION

The present invention relates to credit-based apparatus for controlling data communications, and is particularly concerned with credit recovery.

### BACKGROUND OF THE INVENTION

A known system for controlling data transmission employs a credit-based control approach that provides lossless transmission of data cells. Credits are generated starting at a destination node to reflect its ability to receive data. In an end-to-end implementation, this credit is transmitted back to the next upstream node where the credit is interpreted and modified based on that node's ability to receive data. The process continues through each intermediate node back to the source, where the credit at the source reflects all intermediate credits as well as the one from the destination. Typically, the credits reflect the unused buffer space at each node. The source then interprets the credit as an indication of the amount of data that it can transmit into the network without any data loss due to congestion or buffer overflow.

A variation on the end-to-end credit-based approach is a link-to-link implementation in which adjacent nodes in a switch network, for example, interact to control the flow of data from one node, a sender, to another node, the receiver. The sender supplies data segments for forwarding to the receiver, and the receiver has a finite data receive buffer into which received data segments from the sender are placed. The emptying of the data receive buffer is controlled by a buffer read signal from a downstream entity. In an ideal, uncongested communication fabric, each segment of data could be read from the data receive buffer the cycle after it is written therein from the sender. In such a case, the data receive buffer would never contain more than one data segment. When congestion causes the downstream entity to slow its rate of buffer reads below one per cycle, data segments accumulate in the receive buffer. This reduces the space available for storing future data segments from the sender.

Barley et al disclose in U.S. Pat. No. 6,044,406 issued Mar. 28, 2000, a credit-based flow control checking scheme for controlling data communications in a closed loop system comprising a sender, a receiver and a link coupling the sender and receiver. Their credit-based scheme includes automatically periodically transmitting a credit query from the receiver to the sender and upon return receipt of a credit acknowledge containing the available credit count maintained by the sender, determining whether credit gain or credit loss has occurred subsequent to initialization of the closed loop system. Along with automatically determining whether credit gain or credit loss has occurred, a method/system is presented for automatically correcting the loss or gain without requiring resetting of the closed loop system.

### SUMMARY OF THE INVENTION

An object of the present invention is to provide an improved a credit-based method of controlling data communications.

In accordance with an aspect of the present invention there is provided a credit-based method of controlling the flow of data communications between a sender and a receiver coupled by a link, said method comprising the steps of:

(a) allocating a specified initial number of credits to said sender in an available credit count, a credit representing a predetermined amount of memory space in a credit-managed queue in a receiver reserved to store a data segment received from the sender;

(b) transmitting a data segment across the link from the sender to the receiver and decrementing the available credit count at the sender for the transmitted data segment;

(c) returning a credit from the receiver to the available credit count of the sender with each data segment received and transferred from the credit-managed queue within a multi-purpose physical queue at the receiver; and

(d) checking the number of credits in the closed loop system to ascertain whether credit loss or credit gain has occurred, said credit loss or credit gain potentially affecting control of data communications within the closed loop system.

In accordance with an aspect of the present invention there is provided a credit-based apparatus for controlling data communications between a sender and a receiver coupled by a link, the receiver comprising: a queue for receiving data units from the sender; a credit return module for returning credit in response to transferring a data unit from the credit-managed queue; and a pipe-clean module for assisting the sender in resetting the credits in the closed loop system in response to a message from the sender.

In accordance with an aspect of the present invention there is provided a credit-based apparatus for controlling data communications between a sender and a receiver coupled by a link, the receiver comprising: a credit-managed queue for receiving data units from the sender; a credit return module for returning credit in response to transferring a data unit out of the credit-managed queue; and a pipe-clean module for assisting the sender in resetting the credits in the closed loop system in response to a message from the sender and sending a response to the sender via a second link.

The present invention and embodiments thereof have several advantages over the state-of-the-art.

Firstly, the intelligence as to number of credits in the system is located at the sender end of the link, making it easy to couple the credit mechanisms to the Upstream Datapath Scheduler 12 behaviors.

The CQE circuit can share a physical data queue with other CQE circuits without knowledge of the system level partitioning of the physical data queue (the intelligence is in the CHE), leading to an economical, efficient, and scalable system.

The ability to manage only a portion of the physical data queue with the credit system, while still allowing another portion of the physical data queue for destination dependent tuning, allows for a low jitter, high efficiency tuning of the overall system behavior.

A major advantage is that the pipeclean (PC) does not have to flow through the queue before being returned. The queue could be blocked from dequeue in a real system (for instance someone pulled the fiber) and the PC can still be returned. The flow-thru method fails in that case because the PC gets stuck in the queue and is never returned. The CHE could periodically retry the pipeclean operation and add unnecessary traffic destined to a stalled queue. Similiarly if the queue is larger and/or slow moving there can be a large latency due to how long it takes the PC to flow through the queue. This latency can be critical if the CHE is servicing many queue ends.

### BRIEF DESCRIPTION OF THE DRAWINGS

The present invention will be further understood from the following detailed description with reference to the drawings in which:

FIG. 1 illustrates a communications link 10 using credit-based flow control and credit checking;

FIG. 2 illustrates in a block diagram a credit queue end in accordance with a first embodiment of the present invention;

FIG. 3 illustrates in a block diagram a credit queue end in accordance with a second embodiment of the present invention;

FIG. 4 illustrates in a block diagram a communications link with pipe cleaning;

FIG. 5 illustrates in a block diagram a credit queue end in accordance with a third embodiment of the present invention; and

FIG. 6 illustrates in a block diagram a credit queue end in accordance with a fourth embodiment of the present invention.

### DETAILED DESCRIPTION OF THE PREFERRED EMBODIMENT

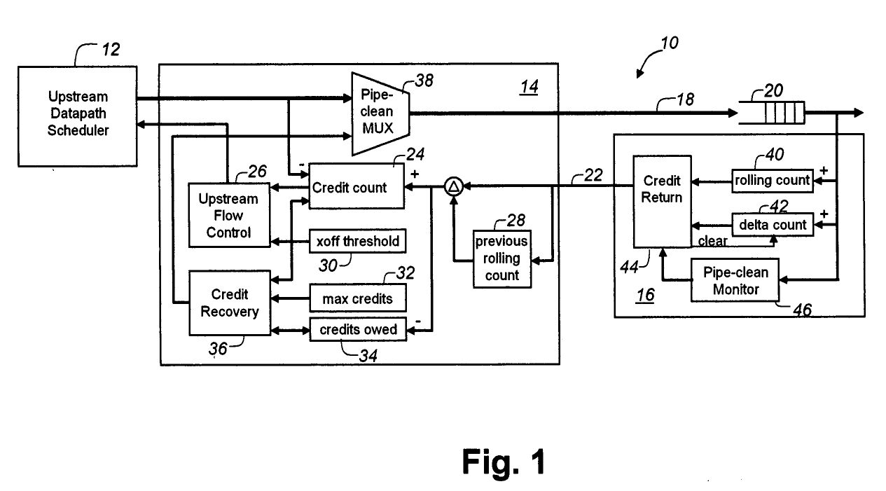

FIG. 1 illustrates a communication link 10 using credit-based flow control and credit checking in a similar way to the baseline implementation of the current invention. Referring to FIG. 1, an upstream datapath scheduler (UDS) 12 controls the data transmitted on the communications link 12. Each communication link 10 includes a credit head end (CHE) 14 and a credit queue end (CQE) 16 coupled by a data link 18 to a data queue 20 and a credit link 22. UDS 12 has a supply of data segments or units (D) to be forwarded via the CHE 14 to the queue 20. A data segment is defined as an amount of data that can be transferred onto the data link in one cycle. For example, a data segment is four bytes of data. If no data segment is sent to CQE 16 in a given cycle, a null (N) appears on the data link. The data segments are supplied by UDS 12.

The CQE has a finite data receive FIFO buffer 20 into which data segments received across data link 18 from CHE 14 are placed. The emptying or consuming of data segments from receive data FIFO buffer 20 is controlled by control logic in response to a FIFO read signal received from a downstream entity (not shown). In an ideal, i.e. uncongested communication fabric, each segment of data (D) would be read from receive data FIFO buffer 20 the cycle after the data is written therein. Thus, buffer 20 ideally would contain no more than one data segment. However, when congestion causes the downstream entity to slow its rate of FIFO reads below one per cycle, data segments can accumulate in the receive data FIFO buffer. This in turn reduces the available space for storing future data segments from CHE 14. The goal of credit-based flow control is to insure that data segments (D) are sent to the CQE 16 at a rate that does not cause overflowing of receive data FIFO buffer 20, while at the same time maximizing utilization of the physical link coupling sender and receiver.

At the time the communication link is established or initialized, the CHE is allocated a number of credits, n, which are stored in max credits 32. Each credit represents permission to transmit one segment of data over data link 18. The credit link 22 is used by the CQE 16 as described herein below to provide the CHE 14 with returned credits. These returned credits flow through credit count 24 to an upstream flow control 26. Because the credit link 22 is separate from the data link 18, transfer of credits from receiver to sender has no affect on data bandwidth. The CHE 14 increments the credit count 24 upon receipt of a credit from CQE 16 and decrements the credit count 24 when a data segment (D) is placed on data link 18 for transmission to the receiver.

The CQE 16 maintains a rolling count 40 and a delta count 42. Both are incremented when a data segment is sent from queue 20. The rolling count 40 is representative of credits associated with data segments having traversed the receive data FIFO buffer 20.

In operation, the Credit Head End (CHE) has a predetermined credit unit, for example a credit unit=4 data bytes; also count 4 byte segment header. The credit count 24 is initializes to a predetermined value=max credits based upon the size of the queue 20. The credit count 24 is decremented by the number of credit units transmitted on the data path 18 for the communications link 10. The credit count 24 is increment by credits returned in each credit return message (CRM) from the credit return 44 determined as equal to current rolling count−previous rolling count

The upstream flow control 26 sends the upstream datapath scheduler 12 an xoff when credit count 24 is greater than or equal to the xoff threshold 30, an xon when credit count 24 is less than the xoff threshold 30. The previous rolling count 28 is initialized to zero.

Basic credit operation of the credit queue end (CQE) 16 includes initializing the rolling count 40 to zero and then incrementing by number of credit units de-queued. The delta count 42 is also initialized to zero and then incremented by the number of credit units de-queued. An update threshold is, for example, set to 17 credits (one 64 B data segment).

The credit return 44 uses the logic, when delta count 42 is greater than or equal to the update threshold, then clear delta count 42 and send the rolling count 40 in a credit return message (CRM) via credit return link 22.

For a multiple channel CQE 16, one could FIFO queue CRM-ready channel IDs. Then read the rolling count 40 and clear delta count 42 on de-queuing from the CRM-ready queue (not shown in FIG. 1).

The design of rolling count as a counter of credits dequeued from system startup instead of a count of credits dequeued since the last CRM adds an important resiliency feature to allow CRM message loss without system error. However, because the communications link 18 and the credit return link 22 are not error free in any real implementation, errors in credit count still occur. It is therefore necessary to reset the number of credits in the credit system to a known value periodically. An example of how this is done with regard to FIG. 1 is provided in the following table.

TABLE A

| Credit Recovery (pipe-clean) | Credit Recovery (Pipe-clean) |
|---|---|
| Operation - CHE | Operation -CQE |
| Initiated by a hardware timer | 3. When a Pipe-clean Message |
| (all active channels pipe-cleaned | (PCM) is dequeued, a CRM |
| in turn). Software can also | is sent, with Pipe-clean |
| initiate pipe-cleaning of any | flag set, carrying the |
| channel or all channels. | rolling_count value |
| 1. credits_owed = | at the PCM dequeue time. |
| max_credits − credit_count | Delta_count is cleared. |
| and Pipe clean Message | The Pipe-clean CRM |
| (PCM) is inserted into datapath. | bypasses the CRM-ready |
| 2. credits_owed decrements by | queue. |
| number of credits returned in | |
| Credit Return Messages, ending | |
| with and including Pipe-clean CRM. | |
| 4. After processing the Pipe-clean | |
| CRM, credits_owed should be zero. | |
| If not, add credits_owed (signed) | |
| to credit_count. | |

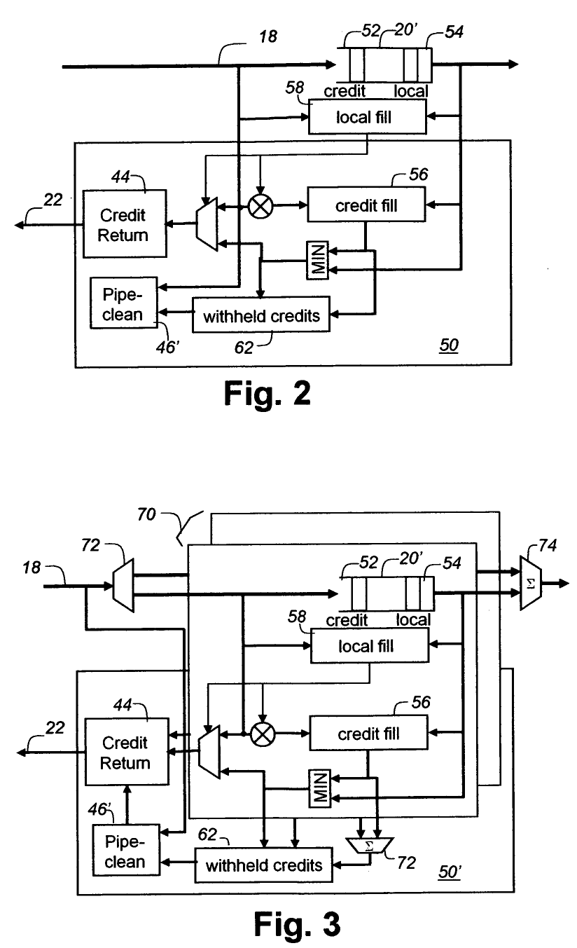

Referring to FIG. 2 there is illustrated in a block diagram a credit queue end in accordance with a first embodiment of the present invention. The first embodiment of the present invention provides a split queue 20′ at the credit queue end 50. While physically implemented as a single queue that behaves like two separate queues a credit managed queue 52 and a locally managed queue 54. A credit fill 56 is used for the credit-managed queue portion 52, which feeds the locally managed queue 54. A local fill 58 is used for the locally managed queue 54. The credits are returned as data is de-queued from the credit-managed queue 52.

The local fill 58 tracks fill of the locally managed queue 54, which is not visible to the CHE 50:
increment/decrement on en-queue/de-queue, respectively
satisfied when greater than credit-local threshold.

The credit fill 56 tracks fill of the credit-managed queue 52:
zero when local fill less than satisfied
increment on en-queue (if not forced to zero by local fill less than satisfied), decrement on local queue de-queue
range: 0 to max credits
   Credit return procedure:
For simplicity, delta count and rolling count are not shown in FIG. 2. In this embodiment, the delta count and rolling count are located at the input of the Credit Return 44. Delta count and rolling count increment:
when local fill is less than satisfied, by credit units en-queued; and
when local fill is greater than or equal to satisfied by MIN (credit units de-queued within credit fill).
The credit return operation otherwise is as described with regard to the known system of FIG. 1.
   Credit recovery (Pipe-clean) operation for CQE 50 replaces step 3 of Table A with the following: 3. The pipe-clean message is returned when it is logically de-queued from the credit part 52 of the split queue 20′:
on pipe-clean message arrival:
copy credit fill 56 into withheld credits 62,
decrement withheld credits 62 when data is dequeued from the credit managed queue (the same time and by the same amount as credit fill is decremented),
and when withheld credits equals 0, return pipe cleaner
Note that withheld credits is zeroed when local fill is less than satisfied; this operation should result in withheld credits also being equal to 0.

The rest of the pipe-clean operation is as described with regard to the known system of FIG. 1.

Referring to FIG. 3 there is illustrated in a block diagram a credit queue end in accordance with a second embodiment of the present invention. The second embodiment uses Multiple-Split Queues in credit queue end (CQE) 50′.

Multiple split queues 70 are credit-managed by a single CHE 50′. These can be used, or example, for priority queuing at the CQE when there are not enough channels between CHE 14 and CQE 50′ to carry each flow-priority on a different channel. Credits are returned as data is de-queued from the credit part 52 of each split queue 20′. Each split queue must be able to absorb max credits, so that a satisfied queue does not block access to an un-satisfied queue.

Each split queue operates the same as a single split queue of FIG. 2. Credit Return is the same as single split queue of FIG. 2, except that each of the multiple split queues 70 returns credits.

Credit Recovery (Pipe-clean) operation for multiple split queues CQE 50′ replaces step 3 of Table A with the following: 3. The pipe-clean message is returned when it is logically de-queued from the credit part of the split queue, as if there were a single credit queue:
on pipe-clean message arrival:
initialise withheld credits 62 with the sum 72 of all credit fill counts 56,
decrement withheld credits 62 when data is dequeued from the credit managed queue (the same time and by the same amount as credit fill 56 is decremented),
and when withheld credits equals 0, return pipe-clean response

Note that withheld credits 62 is zeroed when all local fill 58 are less than satisfied. The rest of the pipe-clean operation is as described with regard to the known system of FIG. 1.

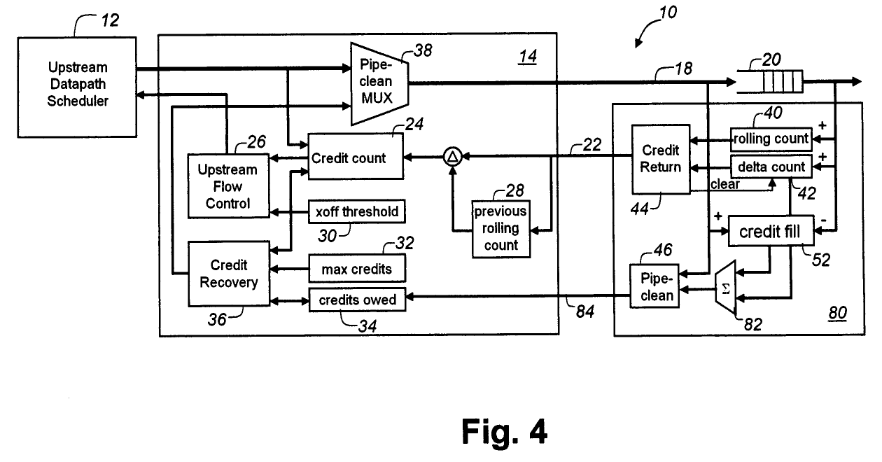

Referring to FIG. 4 there is illustrated in a block diagram a communications link in accordance with a third embodiment of the present invention. The credit queue end 80 includes a credit fill 56 as in FIGS. 2 and 3 whose contents are summed 82 with delta count 42 and applied as input to pipe-clean 46. Pipe clean 46 is directly connected to credits owed 34 via a pipe-clean response link 84.

The basic credit operation for the credit head end (CHE) 14 and credit queue end (CQE) 80 are as described with regard to the known system of FIG. 1.

The pipe-clean operation of the communication link of FIG. 4 is given in the following table:

TABLE B

| Credit Recovery (Pipe-clean) | Credit Recovery (Pipe-clean) |
|---|---|
| Operation -CHE | Operation -CQE |
| Initiated by a hardware timer (all | 2. When a Pipe-clean message |
| active channels pipe-cleaned in | (PCM) is received, it is not |
| turn). Software can also initiate | enqueued, and a pipe-clean |
| pipe-cleaning of any channel or | response (PCR) is sent carrying the |
| all channels. | sum 82 of delta count 42 and credit |
| In present embodiment the Pipe- | fill 52 (the number of credits in |
| clean Response is sent by the | the queue). Delta count is set to |
| CQE 80 upon receipt of the pipe- | zero at the same time. |
| clean message. Unlike the | |
| original flow through scheme of | |
| FIG. 1, the pipe-clean response is | |
| not also a credit return message | |
| (CRM). Instead, it carries the | |
| number of unretumed credits that | |
| are at the queue end when the | |
| Pipe-clean Message arrives. | |
| 1. credits owed = max | |
| credits − credit | |
| count and Pipe-clean Message | |
| (PCM) is inserted into the | |
| datapath. | |
| 3. credits owed decrements by | |
| number of credits returned in | |
| CRM while waiting for the | |
| pipe-clean response and by the | |
| number of credits returned in | |
| the pipe-clean response. | |
| 4. After processing the | |
| Pipe-clean response, credits | |
| owed should be zero. If | |
| not, add credits owed (signed) | |
| to credit count. | |

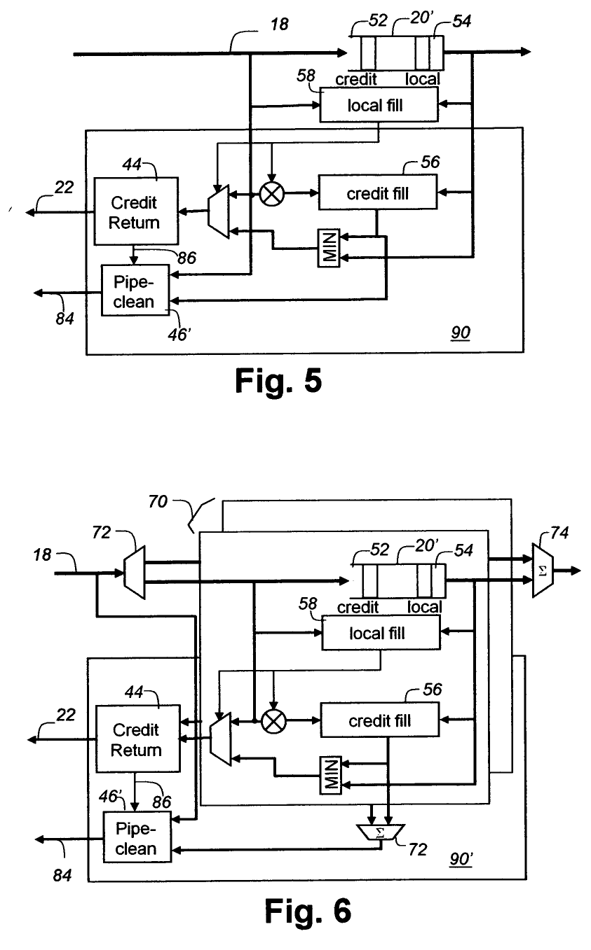

Referring to FIG. 5 there is illustrated in a block diagram a credit queue end in accordance with a fourth embodiment of the present invention. The embodiment of FIG. 5 combines the split queue of FIG. 2 with the pipe-clean arrangement of FIG. 4. Consequently operation of the queue 20′ is as described with regard to FIG. 2. However the credit recovery (pipe-clean) operation replaces step 2 of Table A with the following: 2. When a Pipe-clean Message (PCM) is received at the CQE, it is not enqueued, and a Pipe-clean Response is sent carrying the sum of delta_count and credit_fill (the number of credits in the queue).

FIG. 6 illustrates in a block diagram a credit queue end in accordance with a fifth embodiment of the present invention. The embodiment of FIG. 6 combines the multiple split queues of FIG. 3 with the pipe-clean arrangement of FIG. 4. Consequently operation of the queue 20′ is as described with regard to FIG. 3. However the credit recovery (pipe-clean) operation replaces step 2 of Table A with the following 2. When a Pipe-clean Message (PCM) is received at the CQE, it is not enqueued, and a Pipe-clean Response is sent carrying the sum of delta_count and each credit_fill (the number of credits in all the queues).

Fast Response Compatible Flow Thru Credit Recovery

CHE is set up for Fast Response credit recovery
CQE credit recovery is the same as flow through, except that a separate Pipe-clean Response carrying zero credits is sent after the Credit Return Message that would have been the Pipe-clean Response in pure flow through.

Another embodiment of interest is the ability to share a single queue between multiple CQE. The same mechanisms that allow a CQE to only manage a portion of the queue for split queues, allows a CQE to only manage a portion of a shared queue. In this particular embodiment, the queues tend not to be of the split queue variety because the queuing system must sort the enqueues and dequeues from the credit managed queue to determine which CQE must account for the segments.

Numerous modifications, variations and adaptations may be made to the particular embodiments of the present invention described above without departing from the scope of the invention as defined in the claims.

What is claimed is:

1. A credit-based method of controlling the flow of data communications between a sender and a receiver coupled by a link, said method comprising the steps of:
(a) allocating a specified initial number of credits to said sender in an available credit count, a credit representing a predetermined amount of memory space in a credit-managed queue in a receiver reserved to store a data segment received from the sender;
(b) transmitting a data segment across the link from the sender to the receiver and decrementing the available credit count at the sender for the transmitted data segment;
(c) returning a credit from the receiver to the available credit count of the sender with each data segment received and transferred from the credit-managed queue within a multi-purpose physical queue at the receiver; and
(d) checking the number of credits in the closed loop system to ascertain whether credit loss or credit gain has occurred, said credit loss or credit gain potentially affecting control of data communications within the closed loop system.

2. A credit-based method of claim 1, wherein the multi-purpose physical queue (c) includes a credit managed queue and a locally managed queue each comprising respective portions of a physical queue at the receiver.

3. A credit-based method of claim 2, wherein the partition of the physical queue between the credit managed queue and the locally managed queue is a configurable queue depth.

4. A credit-based method of claim 2, wherein the step of returning includes determining when data crosses between the credit managed queue and the locally managed queue by monitoring the physical queue fill, physical enqueue and physical dequeue events.

5. A credit-based method of claim 1, wherein the multi-purpose physical queue (c) includes a plurality of credit managed queues.

6. A credit-based method of claim 5, including a step of parsing enqueue and dequeue events to the physical queue to determine which of the plurality of credit managed queues is involved.

7. A credit-based method as claimed in claim 1, wherein checking the number of credits can be an automatic periodic process by a circuit or software program.

8. A credit-based method as claimed in claim 1, wherein checking the number of credits can be a manual process instigated by an operator of the link.

9. A credit based method as claimed in claim 1, wherein checking the number of credits can be an automatic process triggered from observed behavior of the system or from indications associated with the system.

10. A credit-based method as claimed in claim 1, wherein said checking the number of credits (d) comprises ascertaining a number of credits missing from the sender by subtracting the available credit count from the initial credit count and comparing the number of credits missing from the sender to the number of credits present in the receiver, both credits not yet returned and data stored, any difference comprising said credit loss or credit gain.

11. A credit-based method as claimed in claim 10, wherein said checking the number of credits further comprises transmitting the number of credits missing from the sender to the receiver on the data communications link for comparison with the credit fill count maintained at the receiver.

12. A credit-based method as claimed in claim 10, wherein said checking the number of credits further comprises including the number of credits in flight between the sender and receiver and vice-versa, amount of data in flight between the sender and receiver and the number of credits in flight between the receiver and sender, in the calculation of credits lost or gained.

13. A credit-based method as claimed in claim 11, wherein said checking the number of credits further comprises transmitting the credit fill count from the receiver to the sender on the same link as used for credit return for comparison with the credits missing from the sender count maintained at the sender.

14. A credit-based method as claimed in claim 13, wherein said checking the number of credits further comprises the sender storing the originally calculated credits missing from sender value, observing all credits returned during the checking process, and performing a calculation of missing or gained credit based on this information and the message from the receiver. The sender uses the missing or gained credits value to modify the available credits counter.

15. A credit-based method as claimed in claim 1, wherein said returning a credit includes using a second link from the receiver to the sender.

16. A second link as claimed in claim 15, wherein the second link is shared with data communications transmitting in the opposite direction.

17. A credit-based method as in claim 1, wherein returning credits are communicated from the receiver to the sender via a message representative of the count of all credits returned since the initialization of the credit system.

18. A credit-based method as in claim 17, wherein the number of credits returned to the sender is determined at the sender by calculating the difference between the credit count communicated by the receiver and the last credit count communicated by the receiver.

19. A credit-based apparatus for controlling data communications between a sender and a receiver coupled by a link, the receiver comprising:
a queue for receiving data units from the sender;
a credit return module for returning credit in response to transferring a data unit from the credit-managed queue; and
a pipe-clean module for assisting the sender in resetting the credits in the closed loop system in response to a message from the sender.

20. A credit-based apparatus as in claim 19, wherein the queue comprises a credit-managed queue and a locally managed queue.

21. A credit-based apparatus as in claim 19, wherein the queue comprises a plurality of credit-managed queues.

22. A credit-based apparatus as claimed in claim 19 wherein the credit return module for returning credit includes a local fill count and a credit fill count and logic responsive to output therefrom for providing a credit return response.

23. A credit-based apparatus as claimed in claim 19 wherein the pipe-clean module for assisting in resetting the credit is coupled to a credit fill count.

24. A credit-based apparatus as claimed in claim 19 wherein the credit return module is coupled to the sender via a second link.

25. A credit-based apparatus as claimed in claim 24 wherein the pipe-clean module is coupled to the sender via the same second link.

26. A credit-based apparatus as claimed in claim 19 wherein the queue comprises a plurality of parallel queues, each partitioned into a credit managed queue and a locally managed queue.

27. A credit-based apparatus as claimed in claim 26 wherein each of the parallel queues has its own local fill count and credit fill count.

28. A credit-based apparatus as claimed in claim 26 wherein the parallel queues share a common local fill count and credit fill count.

29. A credit-based apparatus for controlling data communications between a sender and a receiver coupled by a link, the receiver comprising:
a credit-managed queue for receiving data units from the sender;
a credit return module for returning credit in response to transferring a data unit out of the credit-managed queue; and
a pipe-clean module for assisting the sender in resetting the credits in the closed loop system in response to a message from the sender and sending a response to the sender via a second link.

30. A credit-based apparatus as claimed in claim 29 wherein the pipe-clean module is coupled to a credit fill count.

31. A credit-based apparatus as claimed in claim 29 wherein the queue comprises a plurality of parallel queues.

32. A credit-based apparatus as claimed in claim 29 wherein the queue is shared by a plurality of receivers

33. A credit-based apparatus as claimed in claim 29 wherein the pipe-clean message from the sender traverses the shared data queue before arriving at the pipe-clean module.

34. A credit-based apparatus as claimed in claim 31 wherein each of the plurality of parallel queues is partitioned into a credit managed queue and a locally managed queue.
